(19) United States
(12) Patent Application Publication
(10) Pub. No.: US 2007/0112185 A1
(43) Pub. Date: May 17, 2007

(54) Method for preparing a cellulose ether

(75) Inventors: Vesa Myllymaki, Helsinki (FI); Reijo Aksela, Espoo (FI)

Correspondence Address: BIRCH STEWART KOLASCH & BIRCH, PO BOX 747, FALLS CHURCH, VA, 22040-0747, US

(73) Assignee: Kemira OYJ, Helsinki (FI)

(21) Appl. No.: 10/581,491

(22) PCT Filed: Dec. 2, 2004
(86) PCT No.: PCT/FI04/00730

§ 371 Date: Jan. 16, 2007

(30) Foreign Application Priority Data
Dec. 3, 2003 (FI) 20031763

(51) Int. Cl. C08B 11/20

(52) U.S. Cl. 536/85; 204/157.68

(57) ABSTRACT

The invention relates to a method for preparing a cellulose ether. The method comprises mixing cellulose with an ionic liquid solvent to dissolve the cellulose, and then treating the dissolved cellulose with an etherifying agent in the presence of an inorganic base to form a cellulose ether, and subsequently separating the cellulose ether from the solution, wherein both the dissolution and the etherification are carried out in the absence of an organic base and in the substantial absence of water. Microwave irradiation and/or pressure can be applied to assist in dissolution and etherification.

### FILED OF THE INVENTION

The present invention is directed to a new method for preparing cellulose ethers.

### BACKGROUND ART

Cellulose Ethers

Cellulose etherification is a very important branch of commercial cellulose derivatization. Industrial etherification of cellulose is exclusively performed in heterogeneous systems, starting from alkali cellulose. Due to the side reactions with water present in the aqueous system in large excess and competing with the cellulosic hydroxy groups for the etherifying agent, reagent yield remains considerably below the 100% margin, and a further processing to remove the by-products from the crude cellulose ether is usually required for high purity products.

There is a broad spectrum of commercially available cellulose ethers. To some extent, both the DS as well as the distribution of the substituents can be varied. The chemical constitution of the alkyl halide and to some extent also the alkylene oxide can be changed, resulting also in anionic and cationic cellulose ethers besides the neutral ones. So-called mixed ethers of cellulose with two or even three different ether functions can be achieved by adding simultaneously or consecutively an alkyl chloride and an alkylene oxide to the aqueous alkaline reaction system. Additionally, various silyl ethers have been synthesized by reaction of polymer especially with trialkylchlorosilanes.

The most important properties of cellulose ethers are their solublilty combined with chemical stability and non-toxicity. Due to this, they have found applications, both in swollen or dissolved form, ranging from auxiliaries in large-scale emulsion or suspension polymerization, through to additives for paints and wall paper adhesives, to viscosity enhancers in cosmetics and food-stuffs, etc.

The cellulose ethers are roughly divided into aliphatic cellulose ethers, comprising alkyl ethers, substituted alkyl ethers, hydroxyalkyl ethers and mixed aliphatic ethers of cellulose. The second group comprises aryl and aralkyl ethers of cellulose the third group being silyl ethers of cellulose.

The simpliest alkyl ether of cellulose is methyl cellulose. The commercial products with a DS between 1.5 and 2.0 are nowadays obtained by a Williamson reaction of alkali cellulose with gaseous or liquid CH₃Cl. The methylation, usually classified as an SN2 reaction, results from the nucleophilic attack of the cellulose alkoxido group on the acceptor C atom of the methyl chloride, Scheme 1.

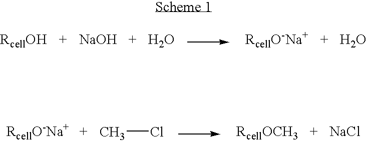

In contrast with about 18% in viscose process, the lye employed for cellulose alkalization contains at least 40% NaOH. The etherification is thus accompanied by the hydrolysis of methyl chloride, with the water present in the system at large molar excess leading to methanol, which in turn can react with methyl chloride to form dimethyl ether. This by-product formation accounts for 20-30% of the CH₃Cl consumption, resulting in a reagent yield for etherification of maximally 80%. Both in etherificafion and by-product formation, 1 mol of NaOH is consumed per mol of CH₃Cl converted, resulting thus in organic by-products but also in a large amount of NaCl.

Going to ethyl cellulose and other higher alkyl ethers the synthesis under heterogenic starting conditions becomes more and more inefficient with increasing molar volume of the alkyl halide. Therefore, the synthesis of alkyl ethers of cellulose with longer side chains usually requires nonaqueous systems, more severe basic reaction conditions, alkyl bromides instead of corresponding chlorides, longer reaction times as well as elevated temperatures, Klemm D.; Philipp B.; Heinze T.; Heinze U.; Wagenknecht W.; Comprehensive Cellulose Chemistry, 2001, Vol. 2, WILEY-VCH, p. 207-214.

From the industrial point of view, the most important cellulose ether so far is carboxymethylcellulose (CMC). It is produced worldwide at a level of 300 000 tons annually, Klemm D.; Philipp B.; Heinze T.; Heinze U.; Wagenknecht W.; Comprehensive Cellulose Chemistry, 2001, Vol. 2, WILEY-VCH, p. 221-234. Here, areas of applications of CMC can be found amongst detergents, food products, paper and paper bound size, oil drilling muds, textiles, pharmaceuticals, paints etc.

Common to all present commercial manufacturing processes (slurry & dry processes) for CMC is the reaction of sodium chloroacetate with alkali cellulose complex represented as R_{cell}OH:NaOH in Scheme 2, step a) below; Kirk-Ohtmer Encyclopedia of Chemical Technology, 4th Ed., Vol. 5, p. 545-548.

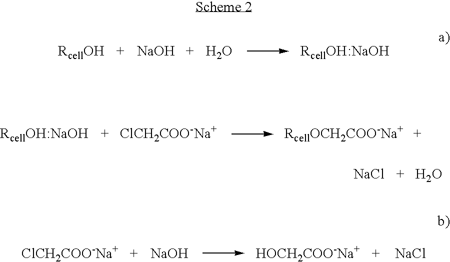

A byproduct formed in the reaction is sodium glycolate, Scheme 2, step b). Just as in cellulose methylation, also in carboxymetylation of cellulose a considerable amount of sodium chloroacetate, i.e. up to 30% is consumed in side reactions with aqueous NaOH; Klemm D.; Philipp B.; Heinze T.; Heinze U.; Wagenknecht W.; Comprehensive Cellulose Chemistry, 2001, Vol. 2, WILEY-VCH, p. 221-234.

Generally, monochloroacetic acid is added to the reaction slurry containing sufficient excess of sodium hydroxide to neutralize the monochloroacetic acid and effect its reaction. The heterogenic reaction is usually conducted in aqueous or aqueous-alcoholic media. Finally, the product is isolated and washed with aqueous alcohol or acetone to remove by-product salts. The reagent yield for carboxy-methylation generally amounts to 60-80% of the monochloroacetate input.

In order to ensure adequate swelling resulting in uniform etherification, present heterogenous manufacturing processes must be conducted in quite dilute conditions (about 5-20 mol of water per mol of anhydroglucose). In order to keep viscosity down, the cellulose moiety can also be oxidated by air and by use of chemical oxidants. This results in lower viscosities in the final product as well. In that case, well-defined conditions must prevail with regard to time, temperature, NaOH concentration, and the presence of catalytic amounts of iron, cobalt, or manganese salts, which catalyze the oxidative depolymerization; Ullmann's Encyclopedia of Industrial Chemistry, Vol A5, p. 461-468.

In order to enhance the fast and uniform course of derivatization with a high degree of conversion, methods for making cellulose derivatives under homogeneous conditions have been developed. The solvents employed can be divided onto derivatizing and nonderivatizing solvents. These include NMMNO (N-methyl-morpholine-N-oxide), concentrated aqueous inorganic salt solutions (Ca(SCN)₂/H₂O, ZnCl/H₂O), molten salt hydrates (NaSCN/KSCN/LiSCN/H₂O), concentrated mineral acids (H₂SO₄/H₃PO₄), carbon disulfide, dimethyl-imidazolone/LiCl and finally mixture of N,N-dimethylacetamide and lithium chloride (DMA/LiCl), Klemm D.; Philipp B.; Heinze T.; Heinze U.; Wagenknecht W.; Comprehensive Cellulose Chemistry, 2001, Vol.1, WILEY-VCH, p.62-68.

Perharps the most promising cellulose dissolution process so far is DMA/LiCl. One advantage claimed with this process is a favorable reagent yield due to rather small consumption for side reactions. This, however, must be viewed relatively in so far as the Cl⁻ present at rather high concentration frequently acts as a competitive nucleophile to the cellulosic hydroxy groups with their rather low nucleophilicity, Klemm D.; Philipp B.; Heinze T.; Heinze U.; Wagenknecht W.; Comprehensive Cellulose Chemistry, 2001, Vol 1, WILEY-VCH, p. 136-165. Also, a low solubility of either one of the reaction components or of the reaction product itself in the medium can limit the degree of conversion achieved. Etherification of cellulose in DMA/LiCl also requires a high excess of reagent and long reaction times. Up to 3 days are usually needed to arrive at high DS values. High excess of NaOH and prolonged reaction times also easily result in considerable chain degradation. Therefore, for instance the synthesis of a fully substituted CMC with a DS of 3 is still a matter of discussion.

Cellulose ethers may have low or high degree of substitution (DS). The degree of substitution of cellulose ethers is a measure of the average number of hydroxyl groups on each anhydroglucopyranose unit (AGU) which are derivatized by substituent groups. As each anhydroglucopyranose unit has three hydroxyl groups available for substitution the maximum possible DS is 3.

Most important commercial hydroxyalkyl cellulose ethers are hydroxyethyl cellulose (HEC) and hydroxypropyl cellulose (HPC). These are prepared in the reaction between the polymer and ethylene oxide or propylene oxide respectively. Hydroxyalkylation with epoxides does not require stoichiometric, but only catalytic amount of OH^{—} ions for the cleavage of the epoxy ring and the formation of C—O bond and the alcohol, Scheme 3.

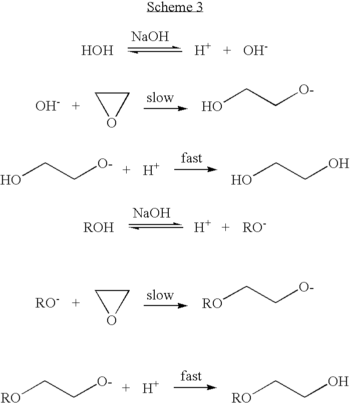

Neither is the hydroxyalkylation limited to the hydroxy groups originally present in the system, but can also proceed further at newly formed hydroxy groups resulting in hydroxyalkyl chains. As presented in Scheme 3, the alkali-catalyzed hydroxyethyl ether formation is accompanied by the reaction of water molecules with ethylene oxide to glycol and polyglycols, with the reagent yield for cellulose etherification amounting to 50-70% of the ethylene input.

The commercial preparation of HEC consists of a slurry process with i-propanol, t-butanol or acetone as the dilutent, employing 0.5-1.5 mol of NaOH/mol of AGU. The reagent yields decrease with higher DS and the low molecular by-products must be washed out by water/alcohol mixtures. Manufacture of hydroxypropyl cellulose (HPC) requires a higher reaction temperature up to or above 100° C. as well as prolonged reaction times due to its lower reaction rate. It is prepared under pressure with liquid propylene oxide or hexane as the reaction medium.

The double reactivity of epichlorohydrin (l-chloro-2,3-epoxypropane) accomplishes the ether crosslinking of cellulose. It combines the reactivity of an alkyl halide with that of an alkylene epoxide in aqueous alkaline medium. Also here, a considerable part of the substrate is consumed in the formation of molecular by-products, especially glycerol.

There is also a large group of other functional alkyl ethers of cellulose. The most important of these are cyanoethylcellulose, aminoethylcellulose, sulfoethylcellulose as well as phosphoromethylcellulose. These have found only limited practical applications, though.

Amongst other cellulose ethers, also aralkyl ethers, aryl ethers as well as silyl ethers have been prepared. Also here, the commercial preparation methods are heterogeneous in nature, the polymer remaining in a highly swollen but solid state throughout the reaction performed in an aqueous alkaline medium.

Dissolution of Cellulose

U.S. Pat. No. 1,943,176 discloses a process for the preparation of solutions of cellulose by dissolving cellulose under heating in a liquefied N-alkylpyridinium or N-benzylpyridinium chloride salt, preferably in the presence of an anhydrous nitrogen-containing base, such as pyridine. These salts are known as ionic liquids. The cellulose to be dissolved is preferably in the form of regenerated cellulose or bleached cellulose or linter. U.S. Pat. No. 1,943,176 also suggests separating cellulose from the cellulose solution by means of suitable precipitating agents, such as water or alcohol to produce for example cellulose threads or films or masses. According to U.S. Pat. No. 1,943,176 the cellulose solutions are suitable for various chemical reactions, such as etherification or esterification. In Example 14 triphenylchloromethane is added to a solution of cellulose in a mixture of benzylpyridinium chloride and pyridine, and subsequently the cellulose solution is poured into methylalcohol to separate the cellulose ether.

Also other cellulose solvents are known. For example, viscose rayon is prepared from cellulose xanthate utilizing carbon disulfide as both reagent and solvent. U.S. Pat. No. 3,447,939 discloses dissolving natural or synthetic polymeric compounds, such as cellulose in a cyclic mono(N-methylamine-N-oxide), especially N-methyl-morpholine-N-oxide.

WO 03/029329 discloses a dissolution method very similar to the one disclosed in U.S. Pat. No. 1,943,176. The main improvement resides in the application of microwave radiation to assist in dissolution. The cellulose to be dissolved is fibrous cellulose, wood pulp, linters, cotton balls or paper, i.e. cellulose in a highly pure form. The inventors of WO 03/029329 have published an article (Swatloski, R. P.; Spear S. K.; Holbrey, J. D.; Rogers, R. D. Journal of American Chemical Society, 2002, 124, p. 4974-4975) focussed on the dissolution of cellulose with ionic liquids, especially 1-butyl-3-methyl-imidazolium chloride, by heating in a microwave oven. The cellulose used in the dissolution experiments was dissolving pulp (from cellulose acetate, lyocell, and rayon production lines), fibrous cellulose and filter paper, i.e. cellulose in a highly pure form that does not contain any significant amounts of lignin. This article also teaches precipitating cellulose from the ionic liquid solution by the addition of water or other precipitating solutions including ethanol and acetone.

Ionic Liquids

The literature knows many synonyms used for ionic liquids. Up to date, “molten salts” is maybe the most broadly applied term for ionic compounds in the liquid state. There is a difference between molten salts and ionic liquids, however. Ionic liquids are salts that are liquid around room temperature (typically −100° C. to 200° C., but this might even exceed 300° C.) (Wassercheid, P.; Welton, T., Ionic Liquids in Synthesis 2003, WILEY-VCH, p. 1-6, 41-55 and 68-81). Therefore, the term RTIL (room temperature ionic liquids) is commonly applied for these solvents.

RTILs are non-flammable, non-volatile and they possess high thermal stabilities. Typically, these solvents are organic salts or mixtures consisting of at least one organic component. By changing the nature of the ions present in an RTIL, it is possible to change the resulting properties of the RTILs. The lipophilicity of an ionic liquid of a RTIL is easily modified by the degree of cation substitution. Similarly, the miscibility with water and other protic solvents can be tuned from complete miscibility to almost total immiscibility, by changing the anion substitution.

All these variations in cations and anions can produce a very large range of ionic liquids allowing the fine-tuning for specific applications. Furthermore, the RTILs are relatively cheap and easy to manufacture. They can also be reused after regeneration.

Microwaves

It is known from the recent literature concerning organic synthesis that the reaction times of the organic reactions are remarkable reduced when the energy necessary for the occurrence of the reaction is introduced to the system by using microwave irradiation. The commonly used frequency for microwave energy is 2.45 GHz. There is a wide and continuously increasing literature available in the area of using microwave techniques in organic synthesis. An example of a short summary article of this topic was published by Mingos in 1994 (D. Michael P. Mingos; “Microwaves in chemical synthesis” in Chemistry and industry 1. August 1994, pp. 596-599). Loupy et. al. have recently published a review concerning heterogenous catalysis under microwave irradiation (Loupy, A., Petit, A., Hamelin, J., Texier-Boullet, F., Jachault, P., Mathe, D.; “New solvent-free organic synthesis using focused microwave” in Synthesis 1998, pp. 1213-1234). Another representative article of the area is published by Strauss as an invited review article (C. R. Strauss; “A combinatorial approach to the development of Environmentaly Benign Organic Chemical Preparations”, Aust. J. Chem. 1999, 52, p. 83-96).

Because of their ionic nature, ionic liquids are excellent media for utilizing microwave techniques. Rogers et al. published in 2002 a method for dissolution of pure cellulose fibers into ionic liquids in the microwave field (Swatloski, R. P.; Spear S. K.; Holbrey, J. D.; Rogers, R. D. Journal of American Chemical Society, 2002, 124, p. 4974-4975). Furthermore, they were able to precipitate the fibers back by mixing this fiber-containing solution with water.

### SUMMARY OF THE INVENTION

It is an object of this invention to provide a method for preparing cellulose ethers.

The invention is based on the surprising discovery that alkaline etherification of cellulose can be conducted in an ionic liquid wherein the reaction between cellulose and the etherifying agent, such as chloroacetic acid/ alkali metal chloroacetate proceeded fast and smoothly and no solubility problems of reagents or the product formed were detected. The good solubility of reagents accomplishes efficient and economic reactions without any unnecessary excess of the inorganic base, such as NaOH, thus preventing also the cellulose chain degradation. The possibility for the severe degradation is further diminished by the mild reaction conditions and low reaction temperatures achieved either by microwave irradiation or by pressure.

Due to good solubility of all the starting materials, the invention also accomplishes the possibility to easily control the DS via the reagent to AGU [anhydro-glucopyranose unit(s)] molar ratio. The invention also accomplishes the possibility to prepare highly or fully substituted cellulose ethers and due to better solubility, mild conditions and shorter reaction times, also a method to produce completely new kind of cellulose ethers. The ionic liquids can be reused after regeneration.

### BRIEF DESCRIPTION OF THE DRAWINGS

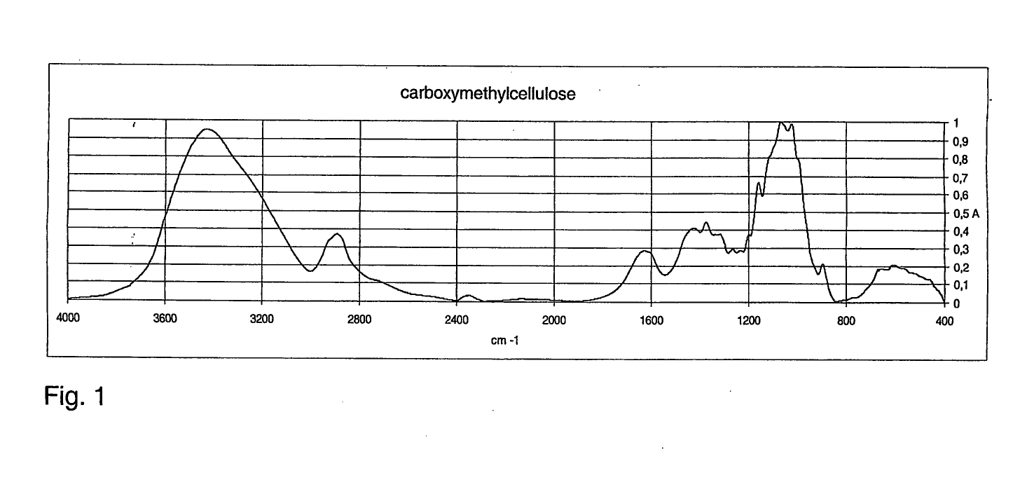

In the enclosed drawing FIG. 1 shows a spectrum obtained by FTIR analysis of a carboxymethylcellulose sample prepared by the method of the present invention.

### DETAILED DESCRIPTION OF THE INVENTION

According to the invention there is provided a method for preparing a cellulose ether comprising mixing cellulose with an ionic liquid solvent to dissolve the cellulose, and then treating the dissolved cellulose with an etherifying agent in the presence of an inorganic base to form a cellulose ether, and subsequently separating the cellulose ether from the solution, wherein both the dissolution and the etherification are carried out in the absence of an organic base and in the substantial absence of water.

The dissolution and etherification can be assisted by applying microwave irradiation and/or pressure.

The pressure is preferably at most 2.0 MPa and more preferably between 1.5 MPa and2.0MPa.

The dissolution of the cellulose can be carried out at a temperature between 0° C. and 250° C., preferably at a temperature between 10° C. and 170° C., such as between 20° C. and 130° C. If microwave irradiation is applied, the heating can be carried out be means of this irradiation. The solution is agitated until complete dissolution is obtained.

In the dissolution as well as in the etherification no auxiliary organic solvents or co- solvents, such as nitrogen-containing bases, e.g. pyridine, are necessary. Organic bases are excluded.

The dissolution and the etherification are carried out in the substantial absence of water. The phrase “in the substantial absence of water” means that not more than a few percent by weight of water is present. Preferably, the water content is less than 1 percent by weight.

The cellulose can be present in the solution in an amount of about 1% to about 35% by weight of the solution. Preferably the amount is from about 10% to about 20% by weight.

The etherification can be carried out at the same temperature as the dissolution or at a lower temperature. No catalysts are necessary, and the etherification is preferably carried out without a catalyst.

The ionic liquid solvent is molten at a temperature between −100° C. and 200° C., 5 preferably at a temperature of below 170° C., and more preferably between −50° C. and 120° C.

The cation of the ionic liquid solvent in preferably a five- or six-membered heterocylic ring optionally being fused with a benzene ring and comprising as heteroatoms one or more nitrogen, oxygen or sulfur atoms. The heterocyclic ring can be aromatic or saturated. The cation can be one of the following: 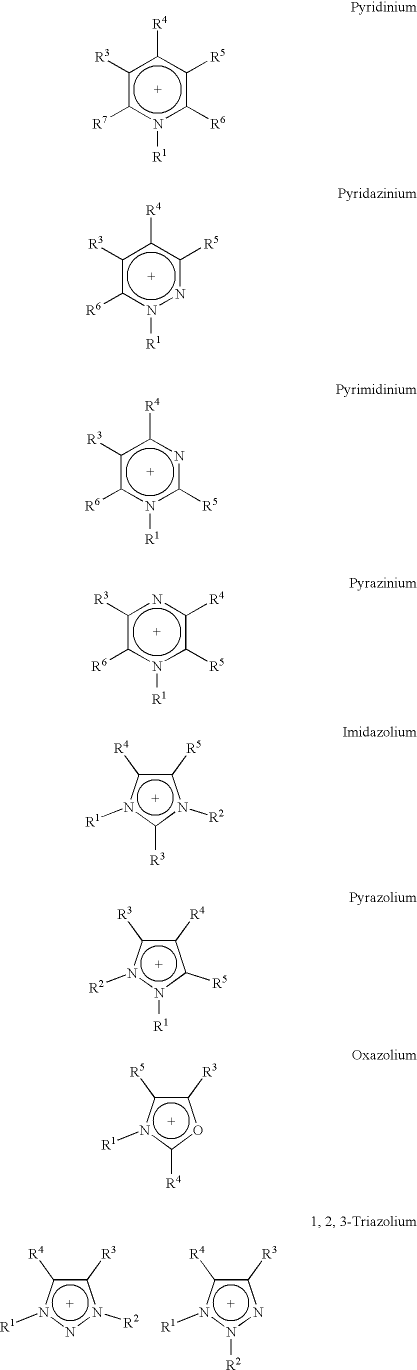 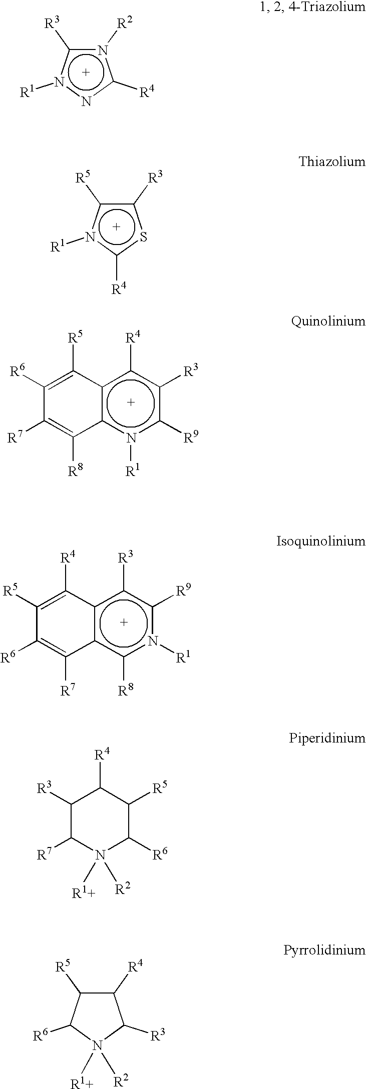
wherein R¹ and R² are independently a C₁-C₆ alkyl or C₂-C₆ alkoxyalkyl group, and R³, R⁴, R⁵, R⁶, R⁷, R⁸ and R⁹ are independently hydrogen, a C₁-C₆ alkyl, C₂-C₆ alkoxyalkyl or C₁-C₆ alkoxy group or halogen.

In the above formulae R¹ and R² are preferably both C₁-C₄ alkyl, and R³-R⁹, when present, are preferably hydrogen.

C₁-C₆ alkyl includes methyl, ethyl, propyl, iso-propyl, butyl, sec-butyl, tert-butyl, pentyl, the isomers of pentyl, hexyl and the isomers of hexyl.

C₁-C₆ alkoxy contains the above C₁-C₆ alkyl bonded to an oxygen atom.

C₂-C₆ alkoxyalkyl is an alkyl group substituted by an alkoxy group, the total number of carbon atoms being from two to six.

Halogen is preferably chloro, bromo or fluoro, especially chloro.

Preferred cations have following formulae: 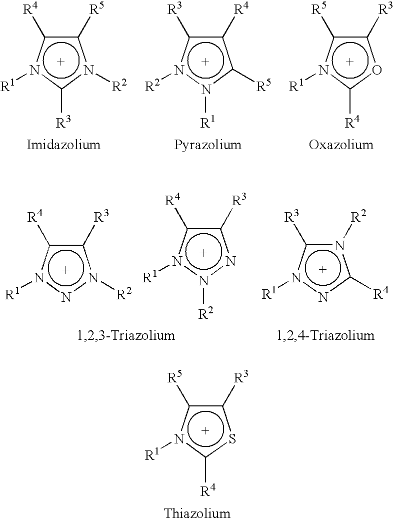
wherein R¹-R⁵ are as defined above.

An especially preferred cation is the imidazolium cation having the formula: 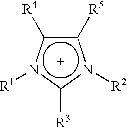
wherein R¹-R⁵ are as defined above. In this formula R³-R⁵ are preferably each hydrogen and R¹ and R² are independently C₁-C₆ alkyl or C₂-C₆ alkoxyalkyl. More preferably one of R¹ and R² is methyl and the other is C₁-C₆ alkyl. In this formula R³ can also be halogen, preferably chloro.

The anion of the ionic liquid solvent can be one of the following:
halogen such as chloride, bromide or iodide;
pseudohalogen such as thiocyanate or cyanate;
perchlorate;
C₁-C₆ carboxylate such as formate, acetate, propionate, butyrate, lactate, pyruvate, maleate, fumarate or oxalate;
nitrate;
C₂-C₆ carboxylate substituted by one or more halogen atoms such as trifluoroacetic acid;
C₁-C₆ alkyl sulfonate substituted by one or more halogen atoms such as trifluoromethane sulfonate (triflate);
tetrafluoroborate BF₄⁻; or
phosphorus hexafluoride PF₆⁻.

The above halogen substituents are preferably fluoro.

The anion of the ionic liquid solvent is preferably selected among those providing a hydrophilic ionic liquid solvent. Such anions include halogen, pseudohalogen or C₁-C₆ carboxylate. The halogen is preferably chloride, bromide or iodide, and the pseudohalogen is preferably thiocyanate or cyanate.

If the cation is a l-(C₁-C₆-alkyl)-3-methyl-imidazolium, the anion is preferably a halogenid, especially chloride.

A preferred ionic liquid solvent is 1-butyl-3-methyl-imidazolium chloride (BMIMCl) having a melting point of about 60° C.

Another type of ionic liquid solvents useful in the present invention is an ionic liquid solvent wherein the cation is a quaternary ammonium salt having the formula 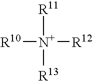
wherein R¹⁰, R¹¹, R¹² and R¹³ are independently a C₁-C₃₀ alkyl, C₃-C₈ carbocyclic or C₃-C₈ heterocyclic group, and the anion is halogen, pseudohalogen, perchlorate, C₁-C₆ carboxylate or hydroxide.

The C₁-C₃₀ alkyl group can be linear or branched and is preferably a C₁-C₁₂ alkyl group.

The C₃-C₈ carbocyclic group includes cycloalkyl, cycloalkenyl, phenyl, benzyl and phenylethyl groups.

The C₃-C₈ heterocyclic group can be aromatic or saturated and contains one or more heteroatoms selected from the group consisting of nitrogen, oxygen and sulfur.

The inorganic base used in the etherification is preferably an alkali metal hydroxide such as litium, sodium or potassium hydroxide.

The ether group of the cellulose ethers prepared by the method of the present invention can be a C₁-C₆ alkyl, aryl or aryl C₁-C₃ alkyl group optionally substituted by one or more functional groups selected from the group consisting of carboxyl, hydroxyl, amino, alkoxy, halogen, cyano, amide, sulfo, phosphoro, nitro and silyl.

The ether group of the cellulose ethers prepared by the method of the present invention can also be a silyl group substituted by three similar or different groups selected from the group consisting of C₁-C₉ alkyl, aryl and aryl C₁-C₃ alkyl.

The aryl group includes phenyl and naphthyl.

The aryl C₁-C₃ alkyl group (also called aralkyl) is an aryl group as defined above bond to the O group of the cellulose by means of an alkyl group containing 1, 2 or 3 carbon atoms. The aryl C₁-C₃ alkyl group includes for example benzyl, diphenylmethyl, trityl and phenylethyl.

Typical cellulose ethers prepared by the method of the present invention include:
methylcellulose and ethylcellulose
2-hydroxyethylcellulose, 2-hydroxypropylcellulose and 2-butylethylcellulose
2-aminoethylcellulose
2-cyanoethylcellulose
carboxymethylcellulose, 2-carboxyethylcellulose and dicarboxymethylcellulose
2-sulfoethylcellulose
2-phosphoromethylcellulose.

Typical cellulose silyl ethers prepared by the method of the present invention include: trimethylsilylcellulose, tert-butyldimethylsilylcellulose, diphenylmethyl-silylcellulose, triphenylsilylcellulose, tribenzylsilylcellulose, thexyl-dimethylsilyl-cellulose and triisopropylsilylcellulose.

According to the present invention the cellulose ethers can be prepared by any of following four reactions (Cell-OH stands for cellulose): 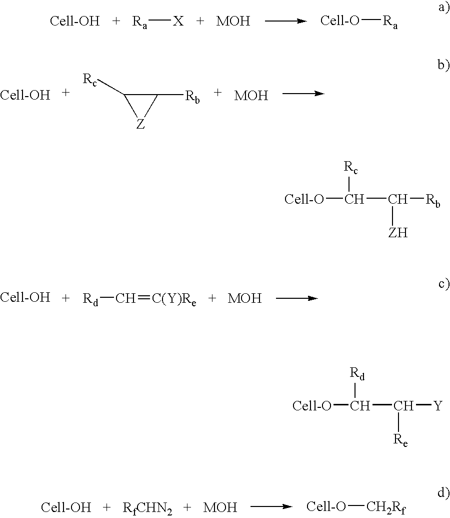
In the above reaction schemes:
M is Li, Na or K,
X is halogen, such as chloride, bromide or iodide, or sulfate,
Rₐ is C₁-C₆ alkyl, aryl or aryl C₁-C₃ alkyl, said alkyl or aryl optionally being substituted by one or more functional groups selected from the group consisting of carboxyl, hydroxyl, amino, alkoxy, halogen, cyano, amide, sulfo, phosphoro, nitro and silyl,
Rₐ can also be silyl substituted by three groups selected from the group consisting of C₁-C₉ alkyl, aryl and aryl C₁-C₃ alkyl,
Z is 0 (the cyclic compound being an epoxide) or NH (the cyclic compound being an aziridine),
R_{b} and R_{c} are independently hydrogen or C₁-C₃ alkyl optionally substituted by one or more functional groups selected from the group consisting of carboxyl, hydroxyl, amino, alkoxy, halogen, cyano, amide, sulfo, phosphoro, nitro and silyl,
Y is an electron-attracting substituent, such as cyano (CN), amide (CONH₂) or sulfo (SO₃⁻Na⁺),
R_{d} and Rₑ are independently hydrogen or C₁-C₃ alkyl, and
R_{f} is C₁-C₅ alkyl.

The aryl and aryl C₁-C₃ alkyl groups are as defined above.

The alkoxy group is preferably C₁-C₆ alkyl-O—.

When preparing cellulose silyl ethers the reactant Rₐ—X is preferably a silyl chloride.

According to the present invention both single-substituted cellulose ethers having only one kind of substituent, and mixed cellulose ethers having two or more different substituents can be prepared.

After the etherification the obtained cellulose ether can be separated from the solution by adding a non-solvent for the cellulose ether to precipitate the cellulose ether. The non-solvent should also be a non-solvent for the ionic liquid solvent and miscible with the ionic liquid solvent. Said non-solvent is preferably an alcohol, such as a C₁-C₆ alkanol, for example methanol, ethanol, propanol or isopropanol. Also other non-solvents, such as ketones (e.g. acetone), acetonitrile, dichloro-methane, polyglycols and ethers can be used. With appropriate DS of the cellulose ether, even water can be employed as a non-solvent.

It is also possible to separate the obtained cellulose ether by extraction with a suitable solvent that is a non-solvent for the ionic liquid solvent.

The main advantages of preferred methods of the present invention for the preparation of cellulose ethers in ionic liquids are as follows:
good solubility of the reagents used
excess of reagents, which in turn would result in cellulose chain degradation, is avoided
fast and economical preparation of cellulose ethers
fast and economical separation of reaction products by precipitating the prepared product by adding a non-solvent for the product, and further, a simple, energy efficient drying procedure of the products
preparation of existing and also new cellulose ether products
dramatically shorter reaction times and lower reaction temperatures by use of microwave irradiation and/or pressure
mild reaction conditions
easy control of the degree of substitution (DS) via the molar ratio of reagent to anhydroglucopyranose unit(s) (AGU)
possibility to prepare highly or fully substituted (DS=3) cellulose ethers
possibility to prepare mixed ethers
possibility to reuse the ionic liquids
   The percentages in this specification refer to % by weight unless otherwise specified.

### EXAMPLE

Carboxymethylation of Cellulose

50 mg of cellulose was dissolved into an ionic liquid (BMIMCl, 5 g, melting point 60° C.) with the aid of microwaves, resulting in 1% solution. Addition of monochloroacetic acid (2.05 eqv.) was followed by addition of slight excess of solid NaOH (3.25 eqv.). The reaction was conducted at 100° C. for two hours under microwave radiation. The product was precipitated by adding methanol to reaction mixture. The precipitate was filtered off and the by-product salts were removed by washing the precipitate with methanol and 80% aqueous methanol solution. The washed product CMC was dried overnight in oven at 105° C. and analysed with FTIR. The obtained spectrum for carboxymethylcellulose is shown in FIG. 1 [1630 cm−1yₐₛ(COO⁻), 1424 cm−1yₛ(COO⁻)].

1. A method for preparing a cellulose ether comprising mixing cellulose with an ionic liquid solvent to dissolve the cellulose, and then treating the dissolved cellulose with an etherifying agent in the presence of an inorganic base to form a cellulose ether, and subsequently separating the cellulose ether from the solution, wherein both the dissolution and the etherification are carried out in the absence of an organic base and in the substantial absence of water.

2. The method according to claim 1 wherein microwave irradiation is applied to assist in dissolution and etherification.

3. The method according to claim 1 wherein pressure is applied to assist in dissolution and etherification.

4. The method according to claim 1 wherein the ionic liquid solvent is molten at a temperature of below 200° C.

5. The method according to claim 1 wherein the cation of the ionic liquid solvent is selected from the group consisting of 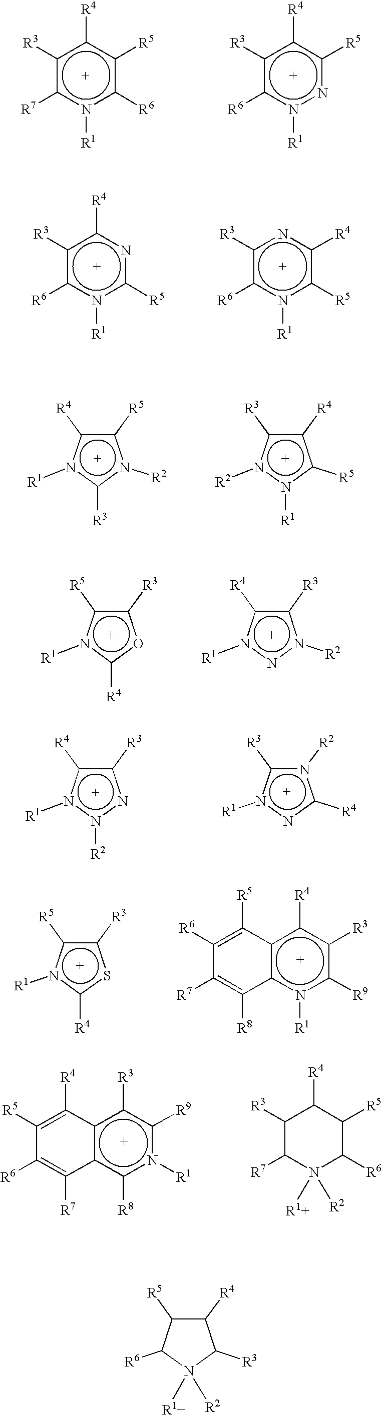
wherein R¹ and R² are independently a C₁-C₆ alkyl or C₂-C₆ alkoxyalkyl group, and R³, R⁴, R⁵, R⁶, R⁷, R⁸ and R⁹ are independently hydrogen, a C₁-C₆ alkyl, C₂-C₆ alkoxyalkyl or C₁-C₆ alkoxy group or halogen, and
wherein the anion of the ionic liquid solvent is halogen, pseudohalogen, perchlorate or C₁-C₆ carboxylate.

6. The method according to claim 5 wherein said cation comprises 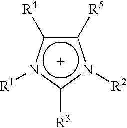
wherein R³-R⁵ are each hydrogen and R¹ and R² are the same or different and represent C₁-C₆ alkyl, and said anion is halogen, preferably chloride.

7. The method according to claim 1 wherein the cation of the ionic liquid solvent is 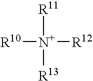
wherein R¹⁰, R¹¹, R¹² and R¹³ are independently a C₁-C₃₀ alkyl, C₃-C₈ carbocyclic or C₃-C₈ heterocyclic group and the anion of the ionic liquid solvent is halogen, pseudohalogen, perchlorate, C₁-C₆ carboxylate or hydroxide.

8. The method according to claim 1 wherein the inorganic base is lithium, sodium or potassium hydroxide.

9. The method according to claim 1 wherein the ether group of the cellulose ether is a C₁-C₆ alkyl, aryl or aryl C₁-C₃ alkyl group optionally substituted by one or more functional groups selected from the group consisting of carboxyl, hydroxyl, amino, alkoxy, halogen, cyano, amide, sulfo, phosphoro, nitro and silyl.

10. The method according to claim 1 wherein the ether group of the cellulose ether is a silyl group substituted by three groups selected from the group consisting of C₁-C₉ alkyl, aryl and aryl C₁-C₃ alkyl.

11. The method according to claim 1 wherein the etherifying agent is a C₁-C₆ alkyl, aryl or aryl C₁-C₃ alkyl halogenide or sulfate optionally substituted by one or more functional groups selected from the group consisting of carboxyl, hydroxyl, amino, alkoxy, halogen, cyano, amide, sulfo, phosphoro, nitro and silyl.

12. The method according to claim 11 wherein the etherifying agent is sodium chloroacetate.

13. The method according to claim 1 wherein the etherifying agent is an epoxide.

14. The method according to claim 1 wherein the etherifying agent is an acrylic compound.

15. The method according to claim 1 wherein the etherifying agent is a diazoalkane compound.

16. The method according to claim 1 wherein the cellulose ether is separated from the solution by adding a non-solvent for the cellulose ether to precipitate the cellulose ether.

17. The method according to claim 16 wherein said non-solvent is an alcohol, ketone, acetonitrile, dichloromethane, a polyglycol, an ether or water.

18. The method according to claim 1 wherein the cellolose ether is separated by extraction whith a non-solvent for the ionic liquid solvent.
